(19) United States
(12) Patent Application Publication
(10) Pub. No.: US 2025/0297477 A1
(43) Pub. Date: Sep. 25, 2025

(54) SUNLIGHT REFLECTING GREENHOUSE TRUSSES

(71) Applicant: SENSEI AG HOLDINGS, INC., Santa Monica (CA)

(72) Inventor: W. Daniel Hillis, Santa Monica, CA (US)

(21) Appl. No.: 18/862,115

(22) PCT Filed: Jun. 12, 2023
(86) PCT No.: PCT/US2023/068281

§ 371 Date: Oct. 31, 2024

Related U.S. Application Data
(60) Provisional application No. 63/351,176, filed on Jun. 10, 2022.

(51) Int. Cl. E04C 3/08; A01G 9/14; E04C 3/04

(52) U.S. Cl. CPC E04C 3/08; A01G 9/14; E04C 2003/0491

(57) ABSTRACT

A greenhouse superstructure that blocks less sunlight entering the greenhouse and therefore does not shade the plants grown in the greenhouse comprises trusses that have a mirrored or otherwise reflective surface facing south. In the northern hemisphere the south end of the greenhouse typically faces the sun, and the sun is always above the horizon during daylight hours. In embodiments of the invention used in the southern hemisphere the reflective surface faces north. A reflective surface, such as a mirror, is placed on the greenhouse trusses with the reflector extending above the top surfaces of the truss. The trusses have an east-west orientation. In this way, sunlight is reflected into the greenhouse by the mirrors during the east-west transit of the sun across the sky. As such, neither the trusses nor the top surfaces of the trusses block the sunlight but, rather, reflect the sunlight down into the greenhouse.

### CROSS-REFERENCE TO RELATED APPLICATION(S)

This application claims priority to U.S. provisional patent application Ser. No. 63/351,176, filed Jun. 10, 2022, which application is incorporated herein in its entirety by this reference thereto.

### TECHNICAL FIELD

Various of the disclosed embodiments concern sunlight reflecting greenhouse trusses.

### BACKGROUND

A greenhouse provides a shelter for plants that duplicates as much as possible the beneficial environmental conditions that are encountered outside of the greenhouse while protecting the plants from environmental extremes, such as extreme temperature variations. A greenhouse requires a roof and walls and a superstructure that supports the roof and walls. While the roof and walls are advantageously made of clear materials, such as glass or plastic, that readily admit sunlight, the superstructure and infrastructure in a conventional greenhouse must be made of solid materials, e.g., to support the roof and walls. Such solid materials shade the plants being grown in the greenhouse. Such shading deprives some of the plants of sunlight while other plants receive full sunlight. This produces an uneven growth pattern among the plants and thus affects the overall quality of the crop produced.

It would be advantageous to provide a greenhouse superstructure that blocks less sunlight entering the greenhouse and that therefore promotes even growth of the plants in the greenhouse because the superstructure does not shade the plants.

### SUMMARY

Embodiments of the invention provide a greenhouse superstructure that blocks less sunlight entering the greenhouse and that therefore does not shade the plants grown in the greenhouse. In embodiments of the invention, the greenhouse superstructure comprises trusses that have a mirrored or otherwise reflective surface facing south. In the northern hemisphere the south end of the greenhouse typically faces the sun, and the sun is always above the horizon during daylight hours. In embodiments of the invention used in the southern hemisphere the reflective surface faces north. Embodiments of the invention place a reflective surface, such as a mirror, on the greenhouse trusses with the reflector extending above the top surfaces of the truss. The trusses have an east-west orientation. In this way, sunlight is reflected into the greenhouse by the mirrors during the east-west transit of the sun across the sky. As such, neither the trusses nor the top surfaces of the trusses block the sunlight but, rather, reflect the sunlight down into the greenhouse.

### BRIEF DESCRIPTION OF THE DRAWINGS

FIG. 1 provides a perspective and end views of a conventional greenhouse truss that shows how sunlight is reflected away from the greenhouse by a conventional greenhouse truss;

FIG. 2 provides end views of a greenhouse truss shows how sunlight is reflected into the greenhouse and toward the plants therein by a greenhouse truss according to the invention; and

FIG. 3 provides perspective view of a section of a reflective extension for a greenhouse truss according to the invention.

### DETAILED DESCRIPTION

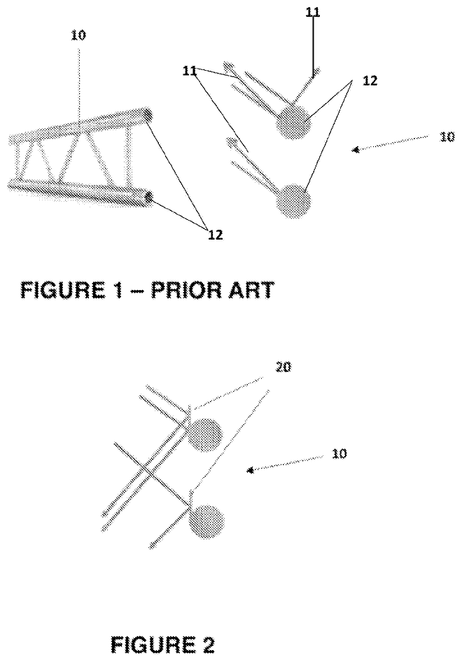

One of the problems with greenhouses is that the trusses that support the greenhouse roof reflect sunlight away from the greenhouse. FIG. 1 shows how sunlight is reflected away from the greenhouse by a conventional greenhouse truss 10 having parallel tubular members 12. As can be seen, sunlight 11 impinging on the truss is reflected upwardly away from the greenhouse. While a conventional greenhouse truss is shown on FIG. 1 as being comprised of tubular members those skilled in the art will appreciate that conventional greenhouse trusses may have different structures. The key feature that such trusses have in common in that they are in the path of sunlight entering the greenhouse and they all block sunlight from reaching at least some of the plants during daylight hours.

The productivity of the greenhouse is proportional to the sunlight that enters the greenhouse. With a conventional truss, such as a round or square tube, sunlight is reflected from the top of the truss, i.e., sunlight is reflected from the surface of the truss, which is horizontal. As such, the greenhouse loses that sunlight because it is reflected back up into the sky. Whereas in embodiments of the invention as discussed below, the sunlight is reflected down to the plants in the greenhouse.

Embodiments of the invention provide a greenhouse superstructure that blocks less sunlight entering the greenhouse and that therefore does not shade the plants grown in the greenhouse. In embodiments of the invention, the greenhouse superstructure comprises trusses that have a mirrored or otherwise reflective surface facing south. In the northern hemisphere the south end of the greenhouse typically faces the sun, and the sun is always above the horizon during daylight hours. In embodiments of the invention used in the southern hemisphere the reflective surface faces north. In embodiments of the invention, the north-south facing portion of the greenhouse roof truss structure does not cast shadows because this portion of the structure is comprised of cables, and the east-west facing portion of the roof truss structure does not cast shadows because of the herein disclosed mirrored truss surfaces.

FIG. 2 shows how sunlight is reflected into the greenhouse and toward the plants therein by a greenhouse truss 10 according to the invention. Embodiments of the invention place a reflective surface, such as a mirror 20, on the greenhouse trusses with the reflector extending above the top surfaces of the truss. The trusses have an east-west orientation. In this way, sunlight is reflected into the greenhouse by the mirrors during the east-west transit of the sun across the sky. As such, neither the trusses nor the top surfaces of the trusses block the sunlight but, rather, reflect the sunlight down into the greenhouse. That is, the mirrors direct light where a shadow would be cast by the truss, avoid casting a shadow by the truss, and therefore avoid dark spots in the bed of greens.

In embodiments of the invention, factors such as the dimensions of the mirrors, the angles at which the mirrors are oriented, and the materials from which the mirrors are made affect the reflection provided by the trusses. The reflective surface of the reflective member may comprise a mirror, a polished surface, or other highly reflective surface. The surface, such as that of a mirror, must be reflective, but it does not have to be a perfectly shiny mirror. In embodiments, the mirror comprises a diffuse mirror that tends to spread the reflected sunlight.

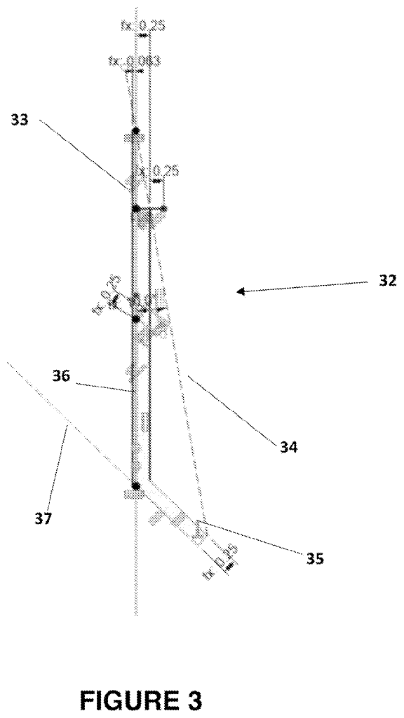

FIG. 3 shows a section of a reflective extension for a greenhouse truss according to the invention. In embodiments of the invention, the reflective extension is attached to the greenhouse truss by any of bolts, straps, adhesives, and the like. In embodiments of the invention, the reflective extension is made of metal, such as aluminum, plastic, ceramic, or other materials. While a section of the reflective extension is shown, it will be appreciated that the structure shown extends substantially along the entire length of the truss.

In FIG. 3 a thin reflective member 32 is attached in front of the thicker truss structure. A portion of the member extends above the truss. The member includes a portion that comprises a substantially vertical extension 33 that shadows the tops of a short horizontal surface 35 and a lower angled surface 36. The portion of the member that is attached to, and contiguous with, the truss is shown with shading in FIG. 3. To minimize the length of the extension it is advantageous to move the part of the reflective member that extends horizontally along the truss as low as possible. Hence the atypical L shape.

The geometry of the mirrors extends beyond the top of the truss. Thus, the truss is mirrored, and there is an downwardly facing extension 33 that is mirrored that prevents light from reflecting upward from the top of the truss (see FIG. 2).

In FIG. 3, construction lines show the maximum angle of the sun 34 and the minimum angle of the sun 37. The angle is chosen based on the highest angle of the sunlight. The angle to vertical is the latitude of the greenhouse plus the apparent radius of the sun. The reflector extends enough to the put the top surfaces of the truss in the shadow of the reflector in the preferred embodiment, even when the sun is at this angle. The actual dimensions of the member and the extension thereof above the truss are determined by several factors, such as latitude, and can be affected by such factors as seasonal position of the sun. In some embodiments the configuration may consider the amount of sunlight reflected at different times of the day, for example to reflect less light when the sun is highest in the sky and more likely to overheat the greenhouse.

In still other embodiments, the configuration may be manually or remotely adjustable to account for changes in the sun's position in the sky due to changes in the seasons. For example, the reflective member may be variably extendable by an electric motor in response to manual or automatic actuation. In embodiments of the invention, a greenhouse monitoring system may operate the electric motor in response to ambient conditions within the greenhouse.

In other embodiments, the dimensions of the reflective member and the reflective extension thereof above the truss are manually or remotely adjustable to account for changes in the sun's position in the sky due to changes during the east-west transit of the sun across the sky.

In other embodiments of the invention elements of the superstructure having a north-south orientation, such as pipes, can include a reflective covering comprised of mirrors or other reflective surfaces arranged in an inverted V. The peak of the V and height of the mirrors affects the amount of additional sunlight reflected into the greenhouse. In some embodiments the configuration may consider the amount of sunlight reflected at various times of the day, for example to reflect less light when the sun is highest in the sky and more likely to overheat the greenhouse.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

I/We claim:

1. A greenhouse superstructure, comprising:
a plurality of trusses substantially having an east-west orientation;
at least one of said trusses comprising a reflective surface;
wherein the reflective surface is placed on the at least one greenhouse truss with a reflector extending above a top surface of the at least one greenhouse truss to reflect sunlight down into the greenhouse, wherein neither the at least one greenhouse truss nor a top surface of the at least one greenhouse truss blocks the sunlight;
wherein the sun is above the horizon during daylight hours and sunlight is reflected into the greenhouse by the reflective surface during the east-west transit of the sun across the sky.

2. The greenhouse superstructure of claim 1, wherein in the northern hemisphere the reflective surface faces south.

3. The greenhouse superstructure of claim 1, wherein in the southern hemisphere the reflective surface faces north.

4. The greenhouse superstructure of claim 1, wherein said reflective surface comprises a mirror.

5. The greenhouse superstructure of claim 4, wherein said mirror comprises a diffuse mirror that spreads reflected sunlight.

6. A greenhouse superstructure having a plurality of truss structures, comprising:
a reflective extension comprising a thin reflective member attached in front of at least one truss structure associated with said greenhouse superstructure and extending substantially along an entire length of said truss structure;
a portion of said reflective member extending above said truss structure and comprising a substantially vertical extension configured to shadow tops of a short horizontal surface and a lower angled surface of said reflective member; and
said reflective extension having an L-shape to minimize a length of said substantially vertical extension.

7. The greenhouse superstructure of claim 6, said thin reflective member further comprising a mirror.

8. The greenhouse superstructure of claim 6, further comprising:
a downwardly facing reflective extension configured to prevent light from reflecting upward from the top surfaces of the truss structure.

9. The greenhouse superstructure of claim 6, wherein the reflective member extends vertically to shadow the truss structure top surfaces.

10. The greenhouse superstructure of claim 6, wherein the dimensions of the reflective member and the reflective extension thereof above the truss are determined by a maximum angle of the sun and a minimum angle of the sun.

11. The greenhouse superstructure of claim 10, wherein an angle to vertical comprises the greenhouse latitude plus the apparent radius of the sun.

12. The greenhouse superstructure of claim 6, wherein the dimensions of the reflective member and the reflective extension thereof above the truss are determined based on a seasonal position of the sun.

13. The greenhouse superstructure of claim 6, wherein the dimensions of the reflective member and the reflective extension thereof above the truss are determined based on an amount of sunlight reflected at different times of the day to reflect less light when the sun is highest in the sky and more likely to overheat the greenhouse.

14. The greenhouse superstructure of claim 6, wherein the dimensions of the reflective member and the reflective extension thereof above the truss are manually or remotely adjustable to account for changes in the sun's position in the sky due to changes in the seasons.

15. The greenhouse superstructure of claim 6, wherein the dimensions of the reflective member and the reflective extension thereof above the truss are manually or remotely adjustable to account for changes in the sun's position in the sky due to changes during the east-west transit of the sun across the sky.
